(19) United States
(12) Patent Application Publication
(10) Pub. No.: US 2005/0131102 A1
(43) Pub. Date: Jun. 16, 2005

(54) Ink composition, image forming method and image forming apparatus

(75) Inventors: Ikuo Nakazawa, Kanagawa (JP); Koichi Sato, Kanagawa (JP); Ryuji Higashi, Kanagawa (JP); Sakae Suda, Kanagawa (JP); Masayuki Ikegami, Kanagawa (JP); Keiichiro Tsubaki, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/958,408

(22) Filed: Oct. 6, 2004

(30) Foreign Application Priority Data
Oct. 10, 2003 (JP) 2003-352925(PAT.)

(51) Int. Cl. C03C 17/00; C09D 11/00

(52) U.S. Cl. 523/160; 523/161

(57) ABSTRACT

An ink composition at least including a colorant, a hydrophobic polymer, an amphiphilic block polymer and a solvent, in which the colorant and the hydrophobic polymer are enclosed in the amphiphilic block polymer and dispersed in the solvent.

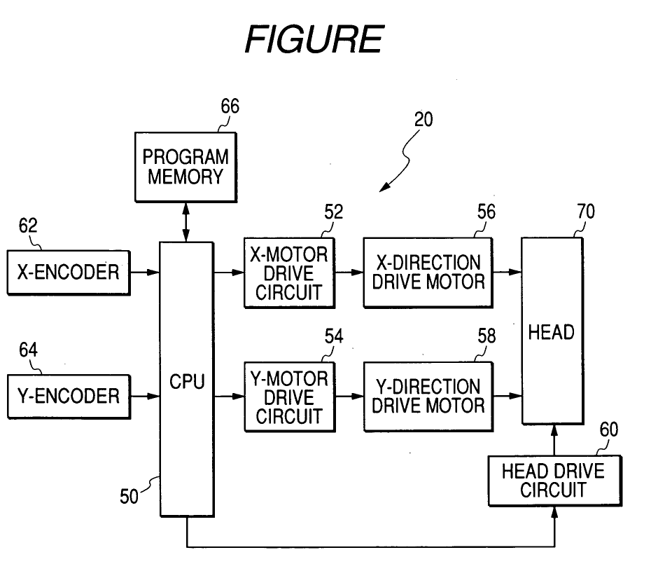

### BACKGROUND OF THE INVENTION

1. Field of the Invention

The present invention relates to an ink composition, an image forming method and an image forming apparatus utilizing such an ink composition.

2. Related Background Art

The digital printing technology is recently showing a remarkable progress. Such digital printing technology is represented by an electrophotographic technology and an ink jet technology, and is increasing importance as an image forming technology in offices and at home.

Among these technologies, the ink jet technology has features of compactness and a low electric power consumption as a direct recording technology. Also an improvement in the image quality is rapidly progressing, for example by a finer structure of nozzles. An example of the ink jet technology is a method of heating an ink, supplied from an ink tank, by a heater in a nozzle to generate a bubble, thereby discharging the ink and forming an image on a recording medium. Another example is a method of causing a vibration in a piezo element, thereby discharging the ink. The advancement of these technologies has achieved a remarkable improvement in the image quality of a digital color print, having reached a level comparable to a silver halide-based photograph. Such digital color print, for replacing a prior silver halide-based photograph or a lithographic print, is required to have a high weather resistance in addition to the high image quality. For the purpose of improving these properties, use of a pigment ink (U.S. Pat. No. 5,085,698, U.S. Pat. No. 6,232,369) and lamination of the print are now studied, but much improvements are still desired.

U.S. Pat. No. 6,232,369 proposes to add a polymer that is insoluble but dispersible in a solvent in a state not enclosing a colorant, thereby improving a friction resistance.

### SUMMARY OF THE INVENTION

The present invention has been made in consideration of such background, and is to provide an ink composition having a high dispersion stability and excellent in a fixing property and a weather resistance.

The present invention is also to provide an image forming method and an image forming apparatus, capable of forming a printed image excellent in a fixing property and a weather resistance, utilizing such ink composition.

A first aspect of the present invention is to provide an ink composition containing at least a colorant, a hydrophobic polymer, an amphiphilic block polymer and a solvent, characterized in that the colorant and the hydrophobic polymer are enclosed in the amphiphilic block polymer and dispersed in the solvent.

A second aspect of the present invention is to provide an image forming method which comprises in including a step of providing a recording medium with the aforementioned ink composition.

A third aspect of the present invention is to provide an image forming apparatus which comprises ink providing means for providing a recording medium with the aforementioned ink composition and drive means for driving the ink providing means.

The present invention provides an ink composition having high dispersion stability and excellent in fixing property and weather resistance.

Also the present invention provides an image forming method and an image forming apparatus, capable of forming a printed image excellent in fixing property and weather resistance, utilizing such ink composition.

### BRIEF DESCRIPTION OF THE DRAWING

FIGURE is a schematic view showing the configuration of an image recording apparatus of the present invention.

### DESCRIPTION OF THE PREFERRED EMBODIMENTS

The present inventors have made the present invention, as a result of intensive study of the background technologies and the problems mentioned in the foregoing.

The present invention provides an ink composition, containing at least a colorant, a hydrophobic polymer, an amphiphilic block polymer and a solvent, characterized in that the colorant and the hydrophobic polymer are enclosed in the amphiphilic block polymer and dispersed in the solvent.

In the ink composition of the present invention, as the colorant and the hydrophobic polymer that shows high affinity to the hydrophobic portion of the amphiphilic block polymer are enclosed in the amphiphilic block polymer, it is estimated that the colorant shows increased affinity to the hydrophobic portion of the amphiphilic block polymer and is more easily enclosed, thereby improving the dispersibility.

The amphiphilic block polymer (hereinafter also abbreviated as block polymer) to be employed in the present invention is not particularly restricted, but is preferably a block polymer of AB, ABC or ABA type. These alphabets indicate segments in the block polymer.

The block polymer may have an ionic portion at an end.

The block polymer preferably includes, at least in one of segments, a polymer portion having a vinyl ether structure. A synthesizing method for a polymer having a vinyl ether structure is already described (Japanese Patent Application Laid-open No. H11-080221), but a cationic living polymerization reported by Aoshima et al. is a representative method (Japanese Patent Application Laid-open Nos. H11-322942 and H11-322866). A polymer synthesis by the cationic living polymerization allows to synthesize a homopolymer, a copolymer formed by two or more monomers, a block polymer, a graft polymer, a graduation polymer or the like with an exactly aligned length (molecular weight). Also in polyvinyl ether, various functional groups can be introduced into a side chain thereof. The cationic polymerization can be executed also in an HI/I₂ system or an HCl/SnCl₄ system.

It is preferred that at least one of the segments of the amphiphilic block polymer has a polyvinyl ether structure, and that a repeating unit structure contained in at least one of the segments of the amphiphilic block polymer is represented by the following general formula (1): 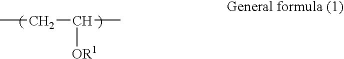
wherein R¹ represents a linear, branched or cyclic alkyl group of with 1 to 18 carbon atoms, —(CH(R₂)—CH(R³)—O)₁—R⁴ or —(CH₂)ₘ—(O)ₙ—R⁴; l and m each independently represents an integer from 1 to 12; n represents 0 or 1; R² and R³ each independently represents a hydrogen atom or CH₃; R⁴ represents a hydrogen atom, a linear, branched or cyclic alkyl group of 1 to 6 carbon atoms, -Ph, -Pyr, -Ph-Ph, -Ph-Pyr, —CHO, —CH₂CHO, —CO—CH═CH₂, —CO—C(CH₃)═CH₂, —CH₂COOR⁵ or -PhCOOR⁵, and, in case R⁴ is other than a hydrogen atom, a hydrogen atom on a carbon atom may be replaced by a linear or branched alkyl group of 1 to 4 carbon atoms, F, Cl or Br while a carbon atom in an aromatic ring may be replaced by a nitrogen atom; and R⁵ represents a hydrogen atom or an alkyl group of 1 to 5 carbon atoms. In the linear or branched alkyl group means methyl, ethyl, n-propyl, i-propyl, n-butyl, sec-butyl, tert-butyl, pentyl, n-hexyl, heptyl, octyl, nonyl, decyl, undecyl, dodecyl, octadecyl etc. Also a cyclic alkyl group means cyclopropyl, cyclobutyl, cyclopentyl, cyclohexyl, cyclooctyl etc. In case a hydrogen atom on a carbon atom is replaced, such substitution may take place in one position or plural positions.

The amphiphilic block polymer in the present invention preferably has a responsiveness to a stimulus, and the molecular structure of the block polymer preferably include the repeating unit of the polyvinyl ether structure represented by the following general formula (2): 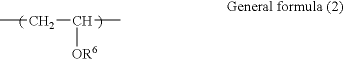
wherein R⁶ represents a linear, branched or cyclic alkyl group of 1 to 18 carbon atoms, -Ph, -Pyr, -Ph- Ph, -Ph-Pyr, —CHO, —(CH₂—CH₂—O)₁—R⁷ or —(CH₂)ₘ—(O)ₙ—R⁷, in which a hydrogen atom on a carbon atom may be replaced by a linear or branched alkyl group of 1 to 4 carbon atoms, while a carbon atom in an aromatic ring may be replaced by a nitrogen atom; 1 and m each independently represents an integer from 1 to 36; n represents 0 or 1; R⁷ represents a hydrogen atom, a linear, branched or cyclic alkyl group of 1 to 18 carbon atoms, -Ph, -Pyr, -Ph-Ph, -Ph-Pyr, —CHO, —CH₂CHO, —CO—CH═CH₂, —CO—C(CH₃)═CH₂, —CH₂COOR⁸ or -PhCOOR⁸, and, in case R⁷ is other than a hydrogen atom, a hydrogen atom on a carbon atom may be replaced by a linear or branched alkyl group of 1 to 4 carbon atoms, F, Cl or Br while a carbon atom in an aromatic ring may be replaced by a nitrogen atom; and R⁸ represents a hydrogen atom or an alkyl group of 1 to 5 carbon atoms.

Preferably, R⁶ represents a linear, branched or cyclic alkyl group of 1 to 18 carbon atoms, -Ph, -Ph-Ph, —(CH₂—CH₂—O)₁—R⁷ or —(CH₂)ₘ—(O)ₙ—R⁷, in which a hydrogen atom on a carbon atom may be replaced by a linear or branched alkyl group of 1 to 4 carbon atoms, while a carbon atom in an aromatic ring may be replaced by a nitrogen atom; 1 represents an integer from 1 to 18; m represents an integer from 1 to 36; n represents 0 or 1; R⁷ represents a hydrogen atom, a linear, branched or cyclic alkyl group of 1 to 18 carbon atoms, -Ph, -Ph-Ph, —CHO, —CO—CH═CH₂, —CO—C(CH₃)═CH₂, —CH₂COOR⁸ or -PhCOOR⁸, and, in case R⁷ is other than a hydrogen atom, a hydrogen atom on a carbon atom may be replaced by a linear or branched alkyl group of 1 to 4 carbon atoms, F, Cl or Br while a carbon atom in an aromatic ring may be replaced by a nitrogen atom; and R⁸ represents a hydrogen atom or an alkyl group of 1 to 5 carbon atoms.

As a repeating unit molecular structure of the block polymer including the polyvinyl ether structure in the ink composition of the present invention, more preferable structures of a vinyl ether monomer are shown in the following, but the polyvinyl ether structure to be employed in the invention is not limited to such examples.

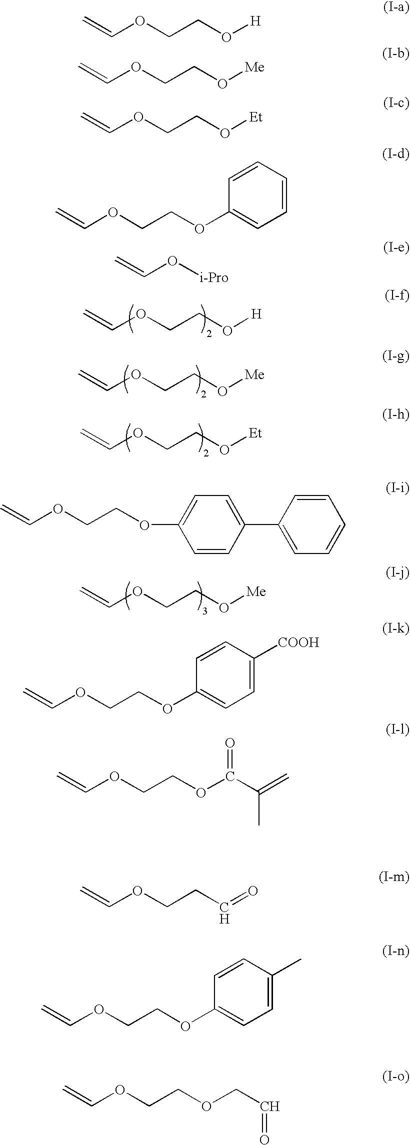

In the monomers (I-l to I-o) constituting the repeating unit represented by the general formula (1), monomers I-l and I-f can constitute a hydrophilic segment, while monomers I-d, I-e, I-i, I-l, I-m, I-n and I-o can constitute a hydrophobic segment. Thermal stimulus responsive segments can be constituted with I-b, I-c, I-g, I-h and I-j, and a pH or ion stimulus responsive segment with I-k.

Such polyvinyl ether may be graft bonded to another polymer, or may be copolymerized with another repeating unit structure. Also each block includes a copolymer of a vinyl ether monomer and another monomer.

In the block copolymer having the polyvinyl ether structure of the invention, the proportion of the hydrophilic segment to the hydrophobic segment is preferably such that the hydrophilic segment represents 5 to 95 mol. % while the hydrdophobic segment represents 5 to 95 mol. %. It is also advantageous to utilizing a stimulus responsive segment. As an example, in case of (I-c), the segment has a heat responsive property and, since hydrophilicity and hydrophobicity can be controlled by temperature, e.g., it behaves as a hydrophilic segment under 20° C. and as a hydrophobic segment over 20° C.

A block polymer constituted of such vinyl ether monomer and including a polyvinyl ether structure can be advantageously utilized in the present invention. The block polymer usable in the present invention is not limited to a polymer constituted of the aforementioned vinyl ether monomer and including the polyvinyl ether structure having a stimulus responsive property. In the following, there are shown examples of such polymer, but the polymer employable in the present invention is not limited to such examples.

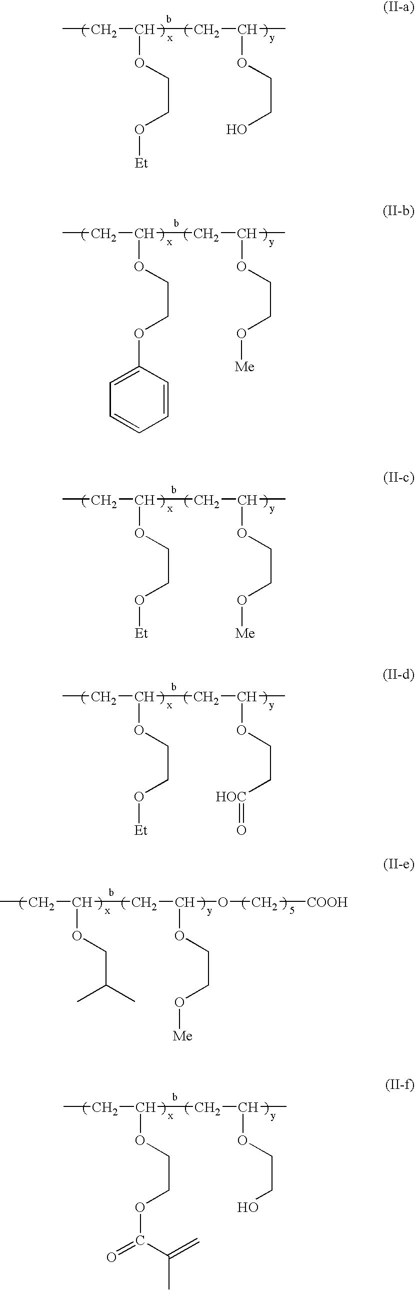

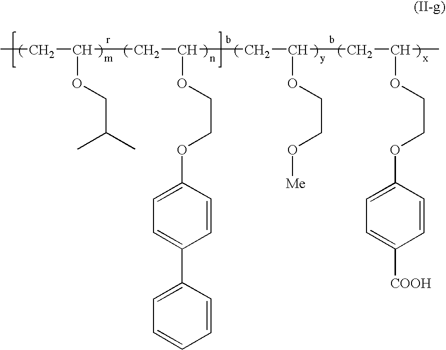

In the structural formulas, b and r represent bonding modes in the copolymer and respectively indicate “block” and “random”.

Also in a number of repeating units of polyvinyl ether (from (II-a) to (II-g)), x, y, m and n each independently represents preferably 1 to 10,000, and a sum thereof (x+y+m+n in (II-a) to (II-g)) is more preferably 10 to 40,000. Also in case each segment in the block polymer including the polyvinyl ether structure is constituted of two or more monomers, each segment may be a random polymer or a gradient polymer.

Also the amphiphilic block polymer preferably has a number-averaged molecular weight (Mn) of 1,000 to 1,000,000, more preferably 2,000 to 500,000. A molecular weight within a range of 1,000 to 1,000,000 provides a desired enclosing function for the amphiphilic block polymer, and an appropriate viscosity. Also the amphiphilic block polymer preferably has a molecular weight distribution (Mw/Mn=weight-averaged molecular weight/number-averaged molecular weight) as small as possible in order to obtain the dispersion stability, preferably 1.8 or less, more preferably 1.6 or less, further preferably 1.3 or less, and particularly preferably 1.2 or less.

In the amphiphilic block polymer, at least one of the segments preferably has a glass transition temperature of 0° C. or less, more preferably −20° C. or less. In an image formation with the ink composition, a lower glass transition temperature improves a fixing property on a recording medium. It is also advantageous for enclosing the colorant and the hydrophobic polymer, because of a flexible molecular structure. Also in consideration of this point, it is preferable to employ the polymer of the vinyl ether structure.

The amphiphilic block polymer contained in the ink composition of the present invention has a content of 0.1 to 30 wt. % with respect to the entire ink composition, preferably 0.5 to 20 wt. % and more preferably 1.0 to 20 wt. %. A content less than 0.1 wt. % may result in decrease in the color density of the ink composition, while a content exceeding 30 wt. % may increase the viscosity of the ink composition.

The hydrophobic polymer contained in the ink composition of the present invention is not particularly restricted, but there is preferred a hydrophobic polymer in which a repeating unit structure contained in at least one of the segments is represented by the following general formula (3): 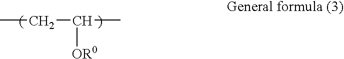
wherein R⁰ represents a linear, branched or cyclic alkyl group of 1 to 18 carbon atoms, —(CH(R²)—CH(R³)—O)₁—R⁴ or —(CH₂)ₘ—(O)ₙ—R⁴; l and m each independently represents an integer from 1 to 12; n represents 0 or 1; R² and R³ each independently represents a hydrogen atom or CH₃; R⁴ represents a hydrogen atom, a linear, branched or cyclic alkyl group of 1 to 6 carbon atoms, -Ph, -Pyr, -Ph-Ph, -Ph-Pyr, —CHO, —CH₂CHO, —CO—CH═CH₂, —CO—C(CH₃)═CH₂, —CH₂COOR⁵ or -PhCOOR⁵, and, in case R⁴ is other than a hydrogen atom, a hydrogen atom on a carbon atom may be replaced by a linear or branched alkyl group of 1 to 4 carbon atoms, F, Cl or Br while a carbon atom in an aromatic ring may be replaced by a nitrogen atom; and R⁵ represents a hydrogen atom or an alkyl group of 1 to 5 carbon atoms.

In the following, representative preferable examples of the hydrophobic polymer of the polyvinyl ether structure represented by the general formula (3) are shown, but such examples are not restrictive:

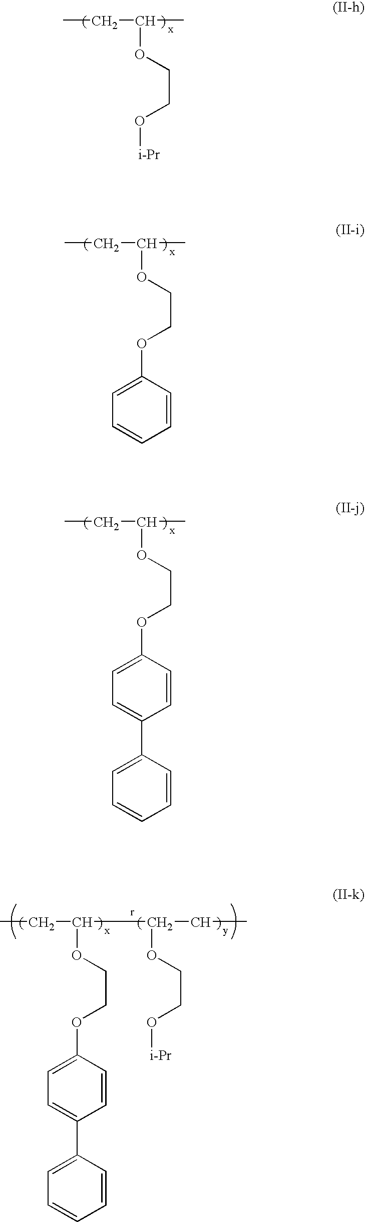

In the structural formulas, r represents a bonding mode in the copolymer and indicates “random”.

Also the number of repeating units of polyvinyl ether of from (II-h) to (II-k), x and y, each independently represents preferably 1 to 1,000, and the sum (x+y) is more preferably 10 to 2,000. Also in case the polymer including the polyvinyl ether structure is constituted of two or more monomers, it may be a random polymer or a gradient polymer.

Also the hydrophobic polymer preferably has a number-averaged molecular weight (Mn) of 1,000 to 1,000,000, more preferably 2,000 to 500,000. A molecular weight within a range of 1,000 to 1,000,000 provides a storage stability of the ink composition.

Also the hydrophobic polymer preferably has a molecular weight distribution as small as possible in order to obtain the storage stability of the ink composition, preferably 1.8 or less, more preferably 1.6 or less, further preferably 1.3 or less, and particularly preferably 1.2 or less.

In the hydrophobic polymer, at least one of the segments preferably has a glass transition temperature of 0° C. or less, more preferably −20° C. or less. A low glass transition temperature provides a flexible molecular structure, thus improving the affinity to the colorant and advantageous for the enclosure by the amphiphilic block polymer. Also in consideration of this point, it is preferable to employ the polymer of the vinyl ether structure. Also the hydrophobic polymer, being enclosed in the amphiphilic block polymer, preferably has a number-averaged molecular weight smaller than that of the block polymer and its content (by weight) in the ink composition smaller than that of the block polymer.

The hydrophobic polymer contained in the ink composition of the present invention has a content of 0.01 to 20 wt. % with respect to the entire ink composition, preferably 0.01 to 10 wt. % and more preferably 0.05 to 5.0 wt. %. A content less than 0.01 wt. % may deteriorate the storage stability of the ink composition, while a content exceeding 20 wt. % may hinder a sufficient enclosure in the amphiphilic block polymer.

One preferred embodiment of the enclosing step of the colorant and the hydrophobic polymer in the amphiphilic block polymer is characterized in that the colorant is dispersed in a solvent, the obtained solution is added to an aqueous solution in which the block polymer and the hydrophobic polymer are dispersed or dissolved, and then the organic solvent is evaporated thereby enclosing the colorant and the hydrophobic polymer in the amphiphilic block polymer owing to the change in the solvent environment. The manufacturing step in the present invention, however, is not limited to such process.

The amphiphilic block polymer is known to assume various self-assembly forms in a solution, such as micelles, cylinders or lamellas, depending on the proportion of the hydrophilic segment and the hydrophobic segment of the amphiphilic polymer, the solution concentration etc. The enclosure described in the present invention is based on a micelle formation of the amphiphilic block polymer. In an example utilizing water as a solvent, the hydrophobic segments aggregates and hydrophilic segments cover therearound to disperse in water. In case a non-water-soluble colorant or a hydrophobic polymer is present in the solution, such hydrophobic substance is taken in the hydrophobic segment portion of the amphiphilic block polymer, thereby being enclosed in the micelle. The micelle formation can be confirmed by a spherical micelle observed in an EF-TEM observation of the ink composition using a cryotransfer. Also an enclosed state can be confirmed by an EELS elemental analysis of a sample. It is also possible to confirm the enclosed state by utilizing a stimulus responsive property of the ink composition. As an example, when an amphiphilic block polymer (II-a) and a pigment as the colorant are used, the amphiphilic block polymer (II-a) functions as a amphiphilic block polymer over 20° C. in water and the pigment and the hydrophobic polymer are taken in the hydrophobic segment (ethoxyethyl vinyl ether portion) of the amphiphilic block polymer while the hydrophilic portion (hydroxyethyl vinyl ether portion) is hydrated with the solvent thereby forming a dispersion. When the ink composition is brought to a temperature below 20° C., the hydrophobic segment responds to the stimulus and becomes hydrophilic. As a result, the micelle is destructed and the pigment and the hydrophobic polymer are no longer enclosed but come into direct contact with the solvent, and, incapable of disperse or dissolve by themselves, they cause a phase separation to generate a precipitate, whereupon the aqueous phase is completely discolored. The enclosure in the micelles of the amphiphilic block polymer can also be confirmed from this fact.

In the following, there will be explained other components contained in the ink composition of the present invention.

The solvent is not particularly restricted, but is preferably water or an aqueous solvent. Also in a preferred embodiment, the ink is used as an ink jet recording ink.

The ink composition of the present invention may contain another solvent for other purposes, other than a solvent for dispersion or a solvent for dissolving the dye. Such other purposes include the stability of suspension/dispersion, rapid drying property on a recording medium such as paper, antifreezing at a low temperature etc. In the present invention, the solvent includes an organic solvent such as a linear, branched or cyclic aliphatic hydrocarbon, an aromatic hydrocarbon, or a heterocyclic aromatic hydrocarbon, an aqueous solution and water.

[Water]

Water contained in the ink composition of the present invention is preferably ion-exchanged water, pure water or ultrapure water from which metal ions are eliminated.

[Aqueous Solvent]

An aqueous solvent can be, for example, a polyhydric alcohol such as ethylene glycol, diethylene glycol, triethylene glycol, polyethylene glycol, propylene glycol, polypropylene glycol, or glycerin; a polyhydrric alcohol ether such as ethylene glycol monomethyl ether, ethylene glycol monoethyl ether, ethylene glycol monobutyl ether, diethylene glycol monoethyl ether, or diethylene glycol monobutyl ether; or a nitrogen-containing solvent such as N-methyl-2-pyrrolidone, replaced pyrrolidone or triethanolamine. Also for accelerating drying of the ink composition on the recording medium, there can be employed a monohydric alcohol such as methanol, ethanol, or isopropyl alcohol.

In the present invention, water and aqueous solvent are preferably employed with a content of 20 to 95 wt. % with respect to the entire weight of the ink composition, more preferably 30 to 90 wt. %.

[Colorant]

A colorant useful in the present invention may be liquid or solid according to the purpose of the ink composition of the invention, or a solid dye dissolved in a solvent.

A pigment can be an organic pigment or an inorganic pigment, and the pigment employed in the ink is preferably a black pigment and primary color pigments of cyan, magenta, yellow, red, green and blue. It is also possible to use a pigment of a color other than the aforementioned colors, a colorless or pale-colored pigment, or a metallic luster pigment. Also a pigment newly synthesized for the present invention can also be used. The pigment to be used preferably has a primary particle size of 50 nm, and it is possible to use a commercially available pigment or to use such pigment by fine particle formation (for example a mechanical crushing such as milling) and by classification.

In the following, examples of the commercially available pigments of black, cyan, magenta and yellow colors are shown.

A black pigment includes Reven 1000 (manufactured by Columbia Carbon Corp.), Mogul-L (manufactured by Cabot Corp.), Color Black FW1 (manufactured by Degussa Inc.), and MA 100 (manufactured by Mitsubishi Chemical Co.), but these examples are not restrictive.

A cyan pigment includes, for example, C.I. Pigment Blue-15:3, C.I. Pigment Blue-15:4 and C.I. Pigment Blue-16, but these examples are not restrictive.

A magenta pigment includes, for example, C.I. Pigment Red-122, C.I. Pigment Red-123, and C.I. Pigment Red-146, but these examples are not restrictive.

A yellow pigment includes, for example, C.I. Pigment Yellow-74, C.I. Pigment Yellow-128 and C.I. Pigment Yellow-129, but these examples are not restrictive.

The pigment employed in the ink composition of the present invention is preferably employed in an amount of 0.1 to 50 wt. % with respect to the weight of the ink composition. A pigment amount less than 0.1 wt. % cannot provide a sufficient image density, while a pigment amount exceeding 50 wt. % may deteriorate the fixing property of the image. A more preferable range is 0.5 to 30 wt. %.

Also a dye, used by dissolving in a solvent, can be a water-soluble dye or an oil-soluble dye.

Each colorant employed in the ink composition of the present invention is preferably employed in an amount of 0.1 to 50 wt. % with respect to the weight of the aqueous composition.

The dye employable in the ink composition of the present invention can be a known one, and can be a direct dye, an acidic dye, a basic dye, a reactive dye, a water-soluble or oil-soluble food dye.

In the following, there are shown specific examples of the dye usable in the ink composition of the present invention, but the present invention is not limited to such examples.

Water-soluble dyes include:
a direct dye such as C.I. Direct Black-17, -51, -154; C.I. Direct Yellow-12, -86, -142; C.I. Direct Red-1, -79, -243; C.I. Direct-6, -71, -199; C.I. Direct Orange-34, -44, -60; C.I. Direct Violet-47, -48; C.I. Direct Brown-109; or C.I. Direct Green-59, an acidic dye such as C.I. Acid Black-2, -112, -208; C.I. Acid Yellow-11, -42, -71; C.I. Acid Red-1, -85, -317; C.I. Acid Blue-9, -93, -254; C.I. Acid Orange-7, -19; or C.I. Acid Violet-49,
a reactive dye such as C.I. Reactive-1, -14, -39; C.I. Reactive Yellow-2, -84, -163; C.I. Reactive Red-3, -128, -221; C.I. Reactive Blue-2, -104, -217; C.I. Reactive Orange-5, -56, -99; C.I. Reactive Violet-1, -22, -38; C.I. Reactive Green-5, -15, -23; or C.I. Reactive Brown-2, -18, -33, and
a basic dye such as C.I. Basic Black-2; C.I. Basic Red-1, -12, -27; C.I. Basic Blue-1, -24, -29; C.I. Basic Violet-7, -14, -27; or C.I. Food Black-1, -2.

Also oil-soluble dye includes Oil Orange 201, Oil Orange PR, Oil Brown BB, Oil Brown GR, Oil Brown 416, Oil Green 502, Valifast Green 1501, Valifast Green 2520, Oil Yellow 129, Oil Yellow GGS, Oil Black 860, Oil Black BS, Oil Black HBB and Oil Black BY.

These examples of the dye are particularly preferable for the ink composition of the present invention, but the dye to be employed in the ink composition of the present invention is not limited to such colorants. The dye employed in the ink composition of the present invention is preferably employed in an amount of 0.1 to 50 wt. % with respect to the weight of the ink. A dye amount less than 0.1 wt. % cannot provide a sufficient image density, while a dye amount exceeding 50 wt. % may deteriorate the fixing property of the image. A more preferred range is 0.5 to 30 wt. %.

[Additives]

The ink composition of the present invention may further contain various additives or auxiliary materials if necessary.

One of the additives for the ink composition is a dispersion stabilizer for stably dispersing the polymer micelles in the solvent. The ink composition of the present invention has a function of stabilizing dispersion by the polymer containing the polyvinyl ether structure, but another dispersion stabilizer may be added in case the dispersion is insufficient.

Another dispersion stabilizer can be a resin or a surfactant having both a hydrophilic portion and a hydrophobic portion.

The resin having both a hydrophilic portion and a hydrophobic portion can be, for example, a copolymer of a hydrophilic monomer and a hydrophobic monomer. A hydrophilic monomer can be, for example, acrylic acid, methacrylic acid, maleic acid, furamic acid, a monoester of the aforementioned carboxylic acid, vinylsulfonic acid, styrenesulfonic acid, vinyl alcohol, acrylamide, or methacryloxyethyl phosphate, and a hydrophobic monomer can be a styrene derivative such as styrene or a-methylstyrene, vinylcyclohexane, a vinylnaphthalene derivative, an acrylate ester, or a metharylate ester. The copolymer can assume various structures such as a random, block or graft copolymer. Naturally the hydrophilic or hydrophobic monomer is not limited to the aforementioned examples.

As a surfactant, there can be employed an anionic, nonionic, cationic or amphoteric surfactant.

An anionic surfactant can be, for example, a fatty acid salt, an alkylsulfonate ester salt, an alkylarylsulfonate salt, an alkyldiaryl ether disulfonate salt, a dialkylsulfosuccinate salt, an alkylphosphate salt, a naphthalenesulfonic acid-formalin condensate; a polyoxyethylenealkylsulfonate ester salt, or a glycerolborate fatty acid ester.

A nonionic surfactant can be polyoxyethylene alkyl ether, a polyoxyethylene-oxypropylene block copolymer, a sorbitan fatty acid ester, a glycerin fatty acid ester, a polyoxyethylene fatty acid ester, polyoxyethylene alkylamine, a fluorinated surfactant or a silicone surfactant.

A cationic surfactant can be an alkylamine salt, a quaternary ammonium salt, an alkylpyridinium salt or an alkylimidazolium salt.

An amphoteric surfactant can be alkylbetain, alkylamine oxide, or phosphatidyl choline. Also the surfactant is not limited to the foregoing examples.

The ink composition of the present invention may further include a composition containing an additive (crosslinking agent) having a function of crosslinking the block polymer in the ink composition. Such composition can be advantageously employed as the ink composition of the present invention. The composition containing the aforementioned crosslinking agent may be used in a configuration of being supplied as a composition separate from the ink composition of the present invention and being contacted when required. More specifically, for example in case of an ink jet recording ink, there are provided an ink tank containing the ink composition of the present invention and an ink tank containing the composition containing the crosslinking agent, and these compositions are separately discharged onto the same recording medium and are mutually contacted. Also there may be adopted a configuration of providing the recording medium in advance with the composition containing the crosslinking agent and discharging the ink composition of the present invention thereon, thus achieving a contact.

Also in the ink composition of the present invention, an aqueous solvent may be added if necessary. Particularly in the use as an ink jet recording ink, the aqueous solvent is used for preventing drying and solidification of the ink in a nozzle portion, and may be used singly or as a mixture. The aqueous solvent can be the same as those explained in the foregoing. A content thereof is 0.1 to 60 wt. % of the total weight of the ink, preferably 1 to 25 wt. %.

Other additives include a pH regulating agent for stabilizing the ink composition and obtaining a stability of the ink composition in the flow path in a recording apparatus, a penetrating agent for accelerating penetration of the ink into the recording medium thereby expediting apparent drying, an antimold agent for prevent mold growth in the ink, a chelating agent for masking metal ions in the ink thereby preventing precipitation of metals in a nozzle or precipitation of insoluble substances in the ink, a defoaming agent for preventing bubble formation during circulation, migration or in preparation of the recording liquid, an antioxidant, a viscosity regulating agent, a conductive agent, an ultraviolet absorber, a water-soluble dye, a dispersion dye, and an oil-soluble dye.

In the following, there will be specifically explained an ink jet recording ink (aqueous dispersion ink), a preferred embodiment of the ink composition of the present invention.

[Preparation of Ink Jet Recording Ink]

In the preparation of the ink composition, a preferred embodiment of the enclosing step of the colorant and the hydrophobic polymer is to disperse or dissolve the colorant in a solvent, add an obtained solution to an aqueous solution in which the block polymer and the hydrophobic polymer are dispersed or dissolved, and remove the organic solvent thereby enclosing the colorant and the hydrophobic polymer in the amphiphilic block polymer by the change in the solvent environment. The manufacturing step in the present invention, however, is not limited to such a process.

The dispersion of the block polymer and the hydrophobic polymer can be achieved for example by a disperser, such as an ultrasonic homogenizer, a laboratory homogenizer, a colloid mill, a jet mill, or a ball mill, which can be employed singly or in a combination.

To dissolve the amphiphilic block polymer, a change in the solubility of the amphiphilic block polymer by an environment, or a stimulus responsive property thereof can be utilized advantageously. For example, in case of (II-c) having a heat responsive property, the hydrophilicity and the hydrophobicity can be controlled by temperature. Thus, water can be employed as the solvent as long as it is 20° C. or less. Also in case a hydrophobic group is present in the amphiphilic block polymer, for example as in (II-b), toluene, chloroform or methanol can be used as a solvent.

A solvent capable of dissolving hydrophobic polymer can be, for example, toluene, chloroform or methanol.

After the preparation of a solution in which the block polymer and the hydrophobic polymer are dissolved or dispersed, the colorant is added to the solution and dispersed with a disperser thereby enclosing the colorant in the block polymer. If necessary, the enclosure can also be achieved by changing a solvent environment, changing the solvent affinity of the block polymer. For example, in case of (II-c), the block polymer is dissolved in an aqueous solvent of 20° C. or less, and then the temperature is elevated higher than 20° C. to change the block polymer to the amphiphilic block polymer thereby enclosing the colorant and the hydrophobic polymer.

A similar process can also be employed in case of utilizing a self-dispersing pigment or an oil-soluble dye.

A second embodiment of the present invention is an image forming method for forming an image by providing a recording medium with an ink composition, characterized in employing the aforementioned ink composition.

A third embodiment of the present invention is an image forming apparatus for forming an image by providing a recording medium with an ink composition, characterized in employing the aforementioned ink composition.

In the following, these will be explained in detail.

[Image Forming Method and Image Forming Apparatus]

The ink composition of the present invention can be employed in various image forming apparatuses of various printing methods, an ink jet method or an electrophotographic method, and for image forming methods utilizing such apparatus.

In the present invention, an ink jet printer employing an ink jet ink includes various ink jet recording apparatus, for example, of a piezo ink jet system utilizing a piezo element, or of a thermal ink jet system generating a bubble in the ink by thermal energy.

The image forming apparatus of the present invention, for example in an ink jet recording ink, an ink amount discharged from a discharge port of a recording head is preferably within a range of 0.1 to 100 picoliters for improving the image resolution.

Particularly in an ink jet recording apparatus of the present invention, a preferred embodiment may include means which brings the ink composition and a composition for giving a stimulus for changing the environment, such as a composition containing an additive (crosslinking agent) for crosslinking the amphiphilic block polymer, into mutual contact. In such an embodiment, the ink composition is fixed on the recording medium by such contact thereby providing an excellent image.

The ink composition of the present invention can also be utilized in an indirect recording apparatus utilizing a recording method in which the ink is printed on an intermediate transfer member and is then transferred onto a recording medium such as paper. It can also be applied to an apparatus utilizing an intermediate transfer member by a direct recording method.

In particular, the ink composition of the present invention can be used in an image forming method and an image forming apparatus of an electrophotographic recording method. For example, such image forming apparatus may be provided with a photosensitive drum for forming a latent image, means for forming a latent image thereon (such as an exposure device), ink providing means, a transfer mechanism and a recording medium. An image formation in such apparatus is achieved by forming a latent image on the photosensitive drum, providing the ink composition of the present invention on the latent image or on a portion other than the latent image, transferring the obtained image on the recording medium by the transfer mechanism and fixing the image.

In the following, an ink jet recording apparatus will be briefly explained with reference to FIGURE. However, FIGURE is merely an example of the configuration, and does not limit the present invention.

FIGURE is a view showing the configuration of an ink jet recording apparatus 20.

FIGURE shows a case of recording on a recording medium by a movement of a head. Referring to FIGURE, a CPU 50 controlling the entire apparatus is connected to an X-direction drive motor 56 and a Y-direction drive motor 58 for driving a head 70 in XY directions, through an X-direction motor drive circuit 52 and a Y-direction motor drive circuit 54. According to a command from the CPU, the X-direction drive motor 56 and the Y-direction drive motor 58 are driven through the X-direction motor drive circuit 52 and the Y-direction motor drive circuit 54, whereby a position of the heat 70 relative to the recording medium is determined.

As shown in FIGURE, the head 70 is connected, in addition to the X-direction motor drive circuit 52 and the Y-direction motor drive circuit 54, to a head drive circuit 60, which drives the head 70 under the control of the CPU 50 thereby executing a discharge of the ink jet recording ink. The CPU 50 is further connected to an X-encoder 62 and a Y-encoder 64, inputting position information of the head 70. A control program is entered in a program memory 66. Based on the position information of the X-encoder 62 and the Y-encoder 64 and on the control program, the CPU 50 moves the head 70 thereby positioning the head 70 and discharging the ink jet recording ink in a desired position on the recording medium. In this manner, a desired image printing can be achieved on the recording medium. Also in an image recording apparatus capable of mounting plural ink jet recording inks, the aforementioned operation is executed by predetermined number of times for the respective ink jet recording inks, whereby a desired image can be printed on the recording medium.

After the discharge of the ink jet recording ink, it is possible, if necessary, to move the head 70 to a position of removing means (not shown) for removing excessive ink sticking to the head and to clean the head 70 for example by wiping. Such cleaning can be achieved by an already known method.

After the printing, the printed recording medium is replaced by a new recording medium, with an unillustrated conveying mechanism for the recording medium.

The aforementioned embodiment of the present invention may be altered or modified within an extent the scope of the present invention. For example, there has been explained an example in which the head 70 is moved in X and Y directions, but it is also possible to execute image printing by moving the head 70 only in the X-direction (or Y-direction) and by moving the recording medium in the Y-direction (or X-direction).

In the present invention, a head provided with means for generating thermal energy (for example an electrothermal converting member or a laser light) as an energy source to be utilized for discharging the ink jet recording ink and executing a discharge of the ink jet recording ink by such thermal energy provides an excellent effect. Such method can achieve a high definition in image printing. Use of the ink composition of the present invention allows to obtain a further improved image printing.

As to the representative configuration and principle, for example the one practiced by the use of the basic principle disclosed in the U.S. Pat. Nos. 4,723,129 and 4,740,796 is preferred. This system is applicable to either of the so-called on-demand type and the continuous type. Particularly the case of the on-demand type is effective because, by applying at least one driving signal which gives rapid temperature elevation exceeding nucleus boiling corresponding to the recording information on an electrothermal converting member arranged corresponding to the sheets or liquid channels holding liquid (ink), thermal energy is generated at the electrothermal converting member to induce film boiling at the heat action surface of the printing head, and a bubble can be consequently formed in the liquid (ink) corresponding one-to-one to the driving signals. By discharging the liquid (ink) through a discharge opening by the growth and shrinkage of the bubble, at least a droplet is formed. By forming the driving signals into pulse shapes, growth and shrinkage of the bubble can be effected instantly and adequately to accomplish more preferable discharging of the liquid (ink) particularly excellent in the response characteristics. As the driving signals of such pulse shapes, those disclosed in the U.S. Pat. Nos. 4,463,359 and 4,345,262 are suitable. Further excellent recording can be performed by employment of the conditions described in the U.S. Pat. No. 4,313,124 of the invention concerning the temperature elevation rate of the above-mentioned heat action surface.

As the configuration of the printing head, in addition to the combinations of the discharging orifice, liquid channel and electrothermal converting member (linear liquid channel or right-angled liquid channel) as disclosed in the above-mentioned respective specifications, the configuration by the use of the U.S. Pat. Nos. 4,558,333 and 4,459,600 disclosing the configuration having the heat action portion arranged in the flexed region is also included in the present invention. In addition, the present invention can also be effectively applied to the configuration of the Japanese Patent Laid-open Application No. S59-123670 using a slit common to a plurality of electrothermal converting members as the discharging portion of the electrothermal converting members or of the Japanese Patent Laid-open Application No. S59-138461 having the opening for absorbing a pressure wave of thermal energy corresponding to the discharging portion. This is because the present invention can achieve secure and efficient recording, regardless of the configuration of the printing head.

Furthermore, the present invention is effectively applicable to the printing head of the full line type having a length corresponding to the maximum width of the printing medium which can be recorded by the printing device, and such printing head may have a configuration realizing such length by the combination of plural printing heads, or a configuration constituted by an integrally formed single printing head.

In addition, the present invention is effective, within the printing apparatuses of the serial type mentioned above, in a printing head fixed to the main body of the printing apparatus, or an exchangeable chip-type printing head enabling electrical connection with the main body of the printing apparatus or ink supply from such main body by being mounted on the main body.

Also the apparatus of the present invention may be provided with liquid droplet eliminating means. Such means allows to achieve a further excellent discharge effect.

Also in the configuration of the printing apparatus of the present invention, the addition of auxiliary means is preferable, because the effect of the present invention can be further stabilized. Specific examples of these may include, capping means, pressurization or suction means, preliminary heating means for effecting heating by an electrothermal converting member, another heating element or a combination thereof, and preliminary discharge means for effecting an idle discharge independent from that for printing.

In the present invention, the system utilizing the aforementioned film boiling is most effective.

### EXAMPLES

In the following, the present invention will be explained in detail by examples, but the present invention is not limited to such examples. In the following examples, there will be explained a method of synthesizing the block polymer of the present invention, and a dispersed dye ink composition as an example of the ink composition. Such examples of polymer synthesis and dispersed dye ink merely show certain of executed examples, but the present invention is not limited to such examples.

### Synthesis Example

<Synthesis of Block Polymer>

Synthesis of a block polymer having a carboxylic acid at an end, formed from isobutyl vinyl ether (IBVE), 2-methoxyethyl vinyl ether (MOVE) and HO(CH₂)₅COOH

A poly[IBVE(isobutyl vinyl ether)-b-MOVE (methoxyethyl vinyl ether)]-O(CH₂)₅COOH (wherein b indicates a block polymer) was synthesized in the following manner.

A glass container, equipped with a 3-way stopcock, was internally replaced with nitrogen, and heated to 250° C. in a nitrogen atmosphere to eliminate adsorbed water. After the system was returned to the room temperature, 12 mmol of IBVE, 16 mmol of ethyl acetate, 0.1 mmol of 1-isobutoxyethyl acetate and 11 ml of toluene were added and the reaction system was cooled. When the temperature in the system reached 0° C., 0.2 mmol of ethyl aluminum sesquichloride (equimolar mixture of diethyl aluminum and ethyl aluminum chloride) were added to initiate polymerization. The molecular weight was monitored by molecular sieve column chromatography (GPC) with time to confirm the completion of polymerization of the component A (IBVE).

Then 12 mmol of component B (MOVE) were added and polymerized. After the completion of polymerization of the component B was confirmed by monitoring with GPC, 30 mmol of HO(CH₂)₅COOEt were added to terminate the polymerization. The reaction mixture was diluted with dichloromethane, then washed three times with 0.6 M hydrochloric acid and three times with distilled water. The obtained organic phase was concentrated and dried on an evaporator to obtain a poly[IBVE-b-MOVE]-O(CH₂)₅COOEt block polymer.

The synthesized compound was identified by GPC and NMR. In particular, an end bonded portion was identified, with an NMR DOSY measurement, by confirming the presence of the end portion in a spectrum of the polymer. Obtained polymer had Mn=2.1×10⁴ and Mw/Mn=1.4, wherein Mn is a number-averaged molecular weight and Mw is a weight-averaged molecular weight.

The end ester portion of the obtained poly[IBVE-b-MOVE]-O(CH₂)₅COOEt was hydrolyzed to obtain desired poly[IBVE-b-MOVE]-O(CH₂)₅COOH, which was identified by NMR.

<Synthesis of Hydrophobic Polymer>

Synthesis of hydrophobic polymer of isobutyl vinyl ether (IBVE)

Poly[IBVE (isobutyl vinyl ether)] was synthesized according to the following process.

A glass container, equipped with a 3-way stopcock, was flashed with nitrogen, and heated to 250° C. in a nitrogen atmosphere to eliminate adsorbed water. After the system was returned to the room temperature, 12 mmol of IBVE, 16 mmol of ethyl acetate, 0.1 mmol of 1-isobutoxyethyl acetate and 11 ml of toluene were added and the reaction system was cooled. When the temperature in the system reached 0° C., 0.2 mmol of ethyl aluminum sesquichloride (equimolar mixture of diethyl aluminum and ethyl aluminum chloride) were added to initiate polymerization. The molecular weight was monitored by molecular sieve column chromatography (GPC) with time to confirm the completion of polymerization of IBVE.

The synthesized compound was identified by GPC and NMR. Mn was 1.0×10⁴ and Mw/Mn was 1.2, wherein Mn is a number-averaged molecular weight and Mw is a weight-averaged molecular weight.

### Example 1

26 parts by weight of the block polymer, having a carboxylic acid end, obtained in Synthesis Example and 200 parts by weight of a sodium hydroxide aqueous solution of pH 11 were agitated for 3 days at 0° C. to dissolve the polymer, thereby obtaining a solution of the polymer in sodium salt form. The polymer was extracted with methylene chloride, dried and isolated by distilling off the solvent. Then 8 parts by weight of the polymer were added to 97 parts by weight of ion-exchanged water and the block polymer was dissolved at 0° C. by a homogenizer.

Then, in 70 parts by weight of toluene, 15 parts by weight of an oil-soluble black dye (Black 860, manufactured by Orient Chemical Industries Ltd.) and 3 parts by weight of the hydrophobic polymer obtained in Synthesis Example were added and dissolved. 20 parts by weight of this liquid colorant were added to 65 parts by weight of the aqueous block polymer solution and dispersed at 0° C. by a homogenizer thereby forming micelles of the block polymer enclosing the colorant and the hydrophobic polymer. The inclusion of the colorant and the hydrophobic polymer was confirmed, as explained before, by an EF-TEM observation using cryotransfer, an EELS elementary analysis and by a stimulus responsive property of the amphiphilic block polymer in the colorant dispersion.

Finally, 10 parts by weight of diethylene glycol and 5 parts by weight of 2-pyrrolidone were added and mixed using a homogenizer, and coarse particles were removed by filtering to prepare an ink composition of the present invention.

This ink composition, when made acidic by an addition of 0.1 N hydrochloric acid, generated black aggromerates, thus indicating a responsive property to a stimulus (pH change).

### Example 2

A 0.1 N hydrochloric acid solution was sprayed in advance on a plain paper. On this paper, the ink composition prepared in Example 1 was applied by spraying.

One minute after the spraying of the ink composition, another white plain paper was pressed on the print under a load of 4.9×10⁴ N/m² and a fixing strength was evaluated by whether the ink sticked to the white plain paper. No ink sticking was observed on the white plain paper. Same results were obtained in the test repeated five times.

### Comparative Example 1

In 94 parts by weight of toluene, 6 parts by weight of an oil-soluble black dye (Black 860, manufactured by Orient Chemical Industries Ltd.) were dissolved, and recording and evaluation of fixing strength were executed in the same manner as in Example 2. Ink sticking to the white plain paper was observed.

<Evaluation of Weather Resistance>

An evaluation of weather resistance was executed with the prints prepared in Example 2 and Comparative Example 1. The evaluation of the weather resistance was executed by exposing the print to the solar light across a window pane facing south, and observing change in the color of the printed sample. As a result, the print of Comparative Example 1 showed a significant fading in comparison with the print of Example 1.

### Comparative Example 2

Four parts by weight of a amphiphilic block polymer (polyethylene glycol-b-polyethylene, number averaged molecular weight: 2250, manufactured by Aldrich Corp., 80 wt. % in ethylene oxide) and 97 parts by weight of ion-exchanged water were agitated for 3 days at 25° C. thereby obtaining an aqueous polymer dispersion.

Then, in 70 parts by weight of toluene, 30 parts by weight of an oil-soluble black dye (Black 860, manufactured by Orient Chemical Industries, Ltd.) were added and dissolved. 20 parts by weight of this liquid colorant were added to 65 parts by weight of the aqueous block polymer solution and dispersed at 25° C. by a homogenizer and the organic solvent was removed by an evaporator. Finally, 10 parts by weight of diethylene glycol and 5 parts by weight of 2-pyrrolidone were added and mixed by a homogenizer, and coarse particles were removed by filtering to prepare an ink composition.

The ink composition was applied for printing by spraying as in Example 2, and, 1 minute after the spraying, another white plain paper was pressed on the printed portion under a load of 4.9×10⁴ N/m² and a fixing strength was evaluated by whether the ink sticks to the white plain paper. Ink sticking was observed on the white plain paper. Same results were obtained in the test repeated five times.

### Comparative Example 3

An evaluation of weather resistance was executed with the print prepared in Comparative Example 2 as in Example 2 and Comparative Example 1. As a result, the print of Comparative Example 2 showed a significant fading in comparison with the print of Example 2.

### Comparative Example 4

Four parts by weight of copolymer formed by a hydrophilic monomer and a hydrophobic monomer (polystyrene-r-polyallyl alcohol, number-averaged molecular weight: 1200, manufactured by Aldrich Corp., 60 mol % styrene) and 97 parts by weight of ion-exchanged water were agitated for 3 days at 25° C. to obtain a polymer dispersion.

Then, in 70 parts by weight of toluene, 15 parts by weight of an oil-soluble black dye (Black 860, manufactured by Orient Chemical Industries, Ltd.) and 3 parts by weight of polystyrene (weight-averaged molecular weight: 800, manufactured by Aldrich Corp.) were dissolved. 20 parts by weight of this liquid colorant were added to 65 parts by weight of the polymer dispersion and dispersed at 25° C. by a homogenizer and the organic solvent was removed by an evaporator. Finally, preparation of an ink composition was tried by adding 10 parts by weight of diethylene glycol and 5 parts by weight of 2-pyrrolidone mixing by a homogenizer, but dispersion stability was unsatisfactory and coarse particles precipitated.

The ink composition of the present invention has a high dispersion stability, an excellent fixing property and an excellent weather resistance, and can be utilized as an ink jet recording ink.

Also the image forming method and the image forming apparatus of the present invention can form a printed image excellent in the fixing property and the weather resistance with the aforementioned ink composition, and can be utilized as an ink jet recording method and an ink jet recording apparatus.

This application claims priority from Japanese Patent Application No. 2003-352925 filed Oct. 10, 2003, which is hereby incorporated by reference herein.

1. An ink composition comprising at least a colorant, a hydrophobic polymer, an amphiphilic block polymer and a solvent, wherein said colorant and said hydrophobic polymer are enclosed in the amphiphilic block polymer and dispersed in the solvent.

2. The ink composition according to claim 1, wherein said amphiphilic block polymer includes at least two block segments.

3. The ink composition according to claim 2, wherein at least one of said amphiphilic block segments has a polyvinyl ether structure.

4. The ink composition according to claim 3, wherein a repeating unit contained in at least one of the segments of said amphiphilic block polymer is represented by a general formula (1): 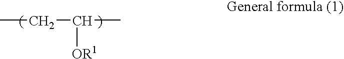
wherein R¹ represents a linear, branched or cyclic alkyl group of 1 to 18 carbon atoms, —(CH(R²)—CH(R³ )—O)₁—R⁴ or —(CH₂)ₘ—(O)ₙ—R⁴; l and m each independently represents an integer from 1 to 12; n represents 0 or 1; R² and R³ each independently represents a hydrogen atom or CH₃; R⁴ represents a hydrogen atom, a linear, branched or cyclic alkyl group of 1 to 6 carbon atoms, -Ph, -Pyr, -Ph-Ph, -Ph-Pyr, —CHO, —CH₂CHO, —CO—CH═CH₂, —CO—C(CH₃)═CH₂, —CH₂COOR⁵ or -PhCOOR⁵, and, in case R⁴ is other than a hydrogen atom, a hydrogen atom on a carbon atom may be replaced by a linear or branched alkyl group of 1 to 4 carbon atoms, F, Cl or Br while a carbon atom in an aromatic ring may be replaced by a nitrogen atom; and R⁵ represents a hydrogen atom or an alkyl group of 1 to 5 carbon atoms.

5. The ink composition according to claim 1, wherein said hydrophobic polymer has at least one segment having a polyvinyl ether structure.

6. The ink composition according to claim 5, wherein at least one of the segments of said hydrophobic polymer contains a repeating structure represented by a general formula (3): 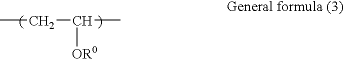
wherein R⁰ represents a linear, branched or cyclic alkyl group of 1 to 18 carbon atoms, —(CH(R²)—CH(R³)—O)₁—R⁴ or —(CH₂)ₘ—(O)ₙ—R⁴; l and m each independently represents an integer from 1 to 12; n represents 0 or 1; R² and R³ each independently represents a hydrogen atom or CH₃; R⁴ represents a hydrogen atom, a linear, branched or cyclic alkyl group of 1 to 6 carbon atoms, -Ph, -Pyr, -Ph-Ph, -Ph-Pyr, —CHO, —CH₂CHO, —CO—CH═CH₂, —CO—C(CH₃)═CH₂, —CH₂COOR⁵ or -PhCOOR⁵, and, in case R⁴ is other than a hydrogen atom, a hydrogen atom on a carbon atom may be replaced by a linear or branched alkyl group of 1 to 4 carbon atoms, F, Cl or Br while a carbon atom in an aromatic ring may be replaced by a nitrogen atom; and R⁵ represents a hydrogen atom or an alkyl group of 1 to 5 carbon atoms.

7. The ink composition according to claim 1, wherein said solvent is water or an aqueous solvent.

8. The ink composition according to claim 1, wherein said hydrophobic polymer has a number-averaged molecular weight smaller than a number-averaged molecular weight of said amphiphilic block polymer.

9. The ink composition according to claim 1, wherein said hydrophobic polymer has a content less than a content of said amphiphilic block polymer.

10. The ink composition according to claim 1, wherein each of said amphiphilic block polymer and said hydrophobic polymer independently has a molecular weight distribution (Mw/Mn) equal to or less than 1.8.

11. The ink composition according to claim 1, wherein each of said amphiphilic block polymer and said hydrophobic polymer independently has a glass transition temperature equal to or less than 10° C.

12. An image forming method comprising a step of providing a recording medium with an ink composition according to any of claims 1 to 11.

13. An image forming apparatus comprising an ink providing means which applies an energy to an ink composition according to any of claims 1 to 11 thereby providing a recording medium with the ink, and a drive means which drives said ink providing means.
